(19) United States
(12) Patent Application Publication
(10) Pub. No.: US 2026/0273571 A1
(43) Pub. Date: Sep. 17, 2026

(54) DISPENSING DEVICE

(71) Applicant: medmix Switzerland AG, Haag (Rheintal) (CH)

(72) Inventors: Nick FITTON, Wiltshire (GB); Mark TINKLER, Berkshire (GB); Stephen DONLON, London (GB); Matt LYNDON, Hampshire (GB); Alex BALL, Wiltshire (GB)

(21) Appl. No.: 19/166,804

(22) PCT Filed: Mar. 21, 2024
(86) PCT No.: PCT/EP2024/057542

§ 371 Date: Sep. 18, 2025

(30) Foreign Application Priority Data
Mar. 27, 2023 (GB) 2304444.9

(51) Int. Cl. B05C 17/01; B05C 17/005

(52) U.S. Cl. CPC B05C 17/0103; B05C 17/0052

(57) ABSTRACT

A dispensing device includes a base structure, a plunger, a driving mechanism and a driving member to transmit the driving force from the driving mechanism to the plunger. The dispensing device includes further a support member on which the driving member is provided, and a guiding device centering a first end of the driving member on the plunger. The support member moves with respect to the base structure translationally and rotationally during a dispensing movement of the driving member to keep the first end of the driving member centered on the plunger.

### CROSS REFERENCE TO RELATED APPLICATIONS

This application is a U.S. national stage application of International Application No. PCT/EP2024/057542, filed on Mar. 21, 2024 which claims priority to United Kingdom Patent Application No. 2304444.9 which was filed on Mar. 27, 2023, the contents of each of which are hereby incorporated by reference.

### TECHNICAL FIELD

The present disclosure relates to dispensing devices for dispensing viscous and non-viscous material(s) from cartridges filled with the material(s).

### BACKGROUND

To date, various configurations for such dispensing devices are known. Such conventional dispensing devices can either dispense single component materials or multi-component materials using e.g. so-called single component cartridges, coaxial cartridges or side by side cartridges, the cartridges can be present as so-called solid cartridge or collapsible respectively sausage bag type cartridges.

### SUMMARY

However, there exists a permanent need for further improvements for such devices.

Therefore, it is an object of the present disclosure to provide an improved configuration for such dispensing devices. This object is solved by the subject matter disclosed herein. Preferable modifications are further disclosed herein.

According to the present disclosure a dispensing device for dispensing viscous and non-viscous material from a cartridge comprises a base structure, a plunger configured to be moved translationally relative to the base structure, a driving mechanism configured to cause the dispensing movement of the plunger with respect to the base structure, and a driving member configured to transmit the driving force from the driving mechanism to the plunger. The dispensing deice comprises further a support member on which the driving member is provided, and guiding means centering a first end of the driving member on the plunger. The support member is configured to move with respect to the base structure translationally and rotationally during a dispensing movement of the driving member to keep the first end of the driving member centered on the plunger.

The translational movement of the support member for centering the driving member allows the prevention of shearing forces acting on the plunger. For the sake for clarity, it is pointed to the fact that the formulation “a driving mechanism configured to cause the dispensing movement of the plunger with respect to the base structure” means effectively that the driving mechanism is configured to effect a movement (in particular via the driving member) of the plunger into and along a cartridge connected to the dispensing device, in particular to the base structure, for pressing the material within the cartridge out of the cartridge for dispensing.

Preferably, the driving member is a bendable rod and the support member is a rod drum wrapped by at least a section of the driving member, in particular more than once, preferably multiple times.

Such a configuration is very robust and allows the implementation of a dispensing device allowing very long dispensing paths for a plunger, in particular for dispensing material from relatively long cartridges. The term “bendable” means in the understanding of this document that the driving member are deformable in a reversable (in particular elastic) manner in perpendicular to is length.

Preferably, the support member is provided rotationally fixed but translationally movable on a splined shaft rotatable with respect to the base structure for causing the dispensing movement of the driving member. The splined shaft is connected to a motor gearbox for rotating the splined shaft.

Such a configuration for driving the support member for causing a dispensing movement of the driving member is very compact but robust.

Preferably, the longitudinal axis of the motor gearbox is aligned in parallel with the longitudinal axis of the cartridge, when connected to the base structure. The motor gearbox is coupled via at least one, preferably multiple, of the following components to the splined shaft: spur gears, compound gears, bevel gears, worms, wheels, belt drives, chains, sprockets and/or friction wheels.

Such a configuration can be implemented with a minimum width. The listed further components allow a reliable coupling of the motor gearbox with the driving spool for implementing very compact overall configurations.

Preferably, the longitudinal axis of the motor gearbox is aligned in perpendicular with the longitudinal axis of the cartridge, when connected to the base structure, and the motor gearbox is coupled directly to the splined shaft.

Such a configuration can be implemented with a minimum of components and, thus, very robust and durable.

Preferably, the support member is configured to move translationally in a direction perpendicular with respect to the translational movement direction of the plunger during the dispensing movement.

Such a configuration is very efficient for preventing undesired shearing forces acting on the plunger.

Preferably, the guiding means comprise a guide bush and/or at least one, in particular multiple, guide wheels.

Such guiding means allow a reliable and well-controlled guiding of the driving member during the dispensing movement

Preferably, the dispensing device is an electrically driven, in particular cordless, handheld device and the driving mechanism comprises a motor gearbox.

In this connection it should be noted that the dispensing device may also be a manual dispensing device comprising a gear lever mechanism in order to convert the action of pulling a lever of the dispensing device into a pushing movement of the plunger.

Preferably the gear lever mechanism is adapted to convert the action of pulling the lever into a continuous or quasi continuous pushing movement of the plunger.

Such a dispensing device is very well to handle and flexibly usable.

Preferably, the dispensing device is a floor dispensing device configured for dispensing material from cartridges with a length of more than 0.5 m and in particular from cartridges with a length of 1.0 m or even more.

For such dispensing devices, the transversal centering movement by the support member is of particular advantage.

Preferably, the dispensing device comprises anti-drip means configured to be operated by a user to release the pressure applied by the driving member onto the plunger and, thus, onto a piston of the cartridge, in particular by causing a small reverse movement of the end section of the driving member connected to the plunger.

With such a configuration, an undesired run-after of the piston in the cartridge and therefrom resulting leakage can be prevented reliably.

Preferably, the anti-drip means comprises an anti-drip finger acting onto the driving member and guiding means for preventing sheering forces onto the plunger when activating the anti-drip finger.

Such a configuration depicts a simple but reliable implementation for anti-drip means.

Preferably, the base structure comprises connection means for connecting a rear end of the cartridge or holding a center portion of the cartridge firmly but releasably. The base structure has a length considerably shorter than the length of the cartridge to be connected thereto.

Such a dispensing device can be formed very compact, in particular for storing the dispensing device.

Preferably, the base structure comprises a telescopically extendable frame configuration configured to hold cartridges of different lengths.

Such a configuration allows the coupling of cartridges of various length reliably to the dispensing device.

Preferably, the base structure is configured such that a cartridge can be connected in a fixed but releasable manner to the base structure.

In other words, when connected to the cartridge and during a dispensing operation, the cartridge does not move with respect to the base structure. However, the cartridge can be released from the base structure to be replaced by a new cartridge.

Preferably, the plunger is configured to be moved translationally into a cartridge connected to the base structure for dispensing material from the cartridge.

Such a translational movement of the plunger results in a controlled dispensing of the material from the cartridge.

Preferably, the dispensing device comprises a stand configured such that the dispensing device can be placed in a substantially vertical orientation stably on the floor.

Such a configuration is very robust and easy to store, even if the dispensing device is implemented rather big.

Preferably, the driving member is bendable and wrapped around the support member. The dispensing device is configured such that a rotational movement of the support member results in an unwrapping of the driving member from the driving spool and, thus, a translational axially directed force from the unwinding driving member onto the plunger resulting in a translational dispensing movement of the plunger with respect to the base structure.

Using a rotation of the support member for driving the driving member results in a very robust overall configuration with less slippage between the driving mechanism and the driving member.

Preferably, a first end of the driving member is firmly connected to the plunger and the second end of the driving member is firmly connected to the support member, in particular via a shaft plug.

Thus, the risk of slippage between the support member and the driving member is minimized.

Preferably, the driving member is a bendable driving rod coupled in a non-releasable manner, in particular via a shaft plug, to the support member.

Such a rod configuration was found to be very robust but still flexible enough for the intended functionality.

Preferably, the driving member is a continuous coil of spring material, such as spring steel, in particular with a diameter of 10 mm to 25 mm, preferably with a diameter of 13 mm to 22 mm, wherein the coil is in particular formed of a wire with an essentially square cross section and/or a thickness corresponding to the pitch of the coil.

In this way a cost-effective spring can be implemented in the dispensing device. In this connection other kinds of metals or materials can be used other than steel. These features for the driving member have been found to result in a simple and robust but still reliable overall dispenser configuration.

Preferably, the driving member is formed from first components of flexible material and second components of rigid material coupled to each other such that the driving member is configured to transmit lateral forces along its length but to bend upon transversal forces acting thereon.

Such a configuration enables a highly optimized implementation for the driving member with various options for customization. The term “rigid” means in the understanding of this document that the corresponding components are not deformable by forces of an amount expected to act on the respective components during a normal operation of the driving device. The term “flexible” means in the understanding of this document that the corresponding components are deformable by forces of an amount expected to act on the respective components during a normal operation of the driving device.

Preferably, the driving member is formed of multiple essentially identical segments connected to each other non-releasably. Each of the segments comprises in particular at least one, prefer-ably multiple, spring members, joint members and/or spacers.

Via identical segments, the costs for producing the driving member can be reduces, while the listed components have been found to be suitable for forming robust and reliable driving members.

Preferably, the driving member is configured to convert a rotational driving movement of the support member into a translational dispensing movement of the plunger.

This implementation allows very compact overall configurations.

Preferably, the base structure is configured such that 2k cartridges, e.g. a so-called side by side cartridge, can be connected in parallel to each other in a fixed but releasable manner to the base structure. The dispensing device comprises one separate plunger and one separate driving member for each cartridge but only one common driving mechanism. The driving mechanism comprises in particular one separate support member for each driving member each driven by one single, preferably electric, common motor gearbox.

With such a dispensing device, material can be dispensed from 2k cartridges simultaneously without the necessity of providing a further dispensing device. By using one common driving mechanism for the separate plungers, the dispensing process is synchronized for the 2k cartridges in a reliable manner.

### BRIEF DESCRIPTION OF THE DRAWINGS

Exemplary configurations and functions of the present disclosure are described herein in conjunction with the following figures, wherein:

FIG. 1 shows a photo of an exemplary prototype for a dispensing device developed in conjunction with the present disclosure;

FIG. 2A shows a schematic perspective view of the internal configuration of a first exemplary dispensing device;

FIG. 2B shows a side view of the configuration of FIG. 2A;

FIG. 3 shows a side view of a dispensing device similar to the one of FIGS. 2A and 2B but supplemented by a handle configuration;

FIG. 4A shows a photo of an end portion of an exemplary driving member, which can be used in the developed dispensing devices;

FIG. 4B shows a photo of a mid-section of the driving member of FIG. 4A in a bent state;

FIG. 5A shows a schematic illustration of the configuration of other driving members, which can be used in the developed dispensing devices;

FIG. 5B shows a photo of a first exemplary implementation of a driving member in accordance with the configuration of FIG. 5A;

FIG. 5C shows a photo of a second exemplary implementation of a driving member in accordance with the configuration of FIG. 5A;

FIG. 5D shows a photo of a third exemplary implementation of a driving member in accordance with the configuration of FIG. 5A;

FIG. 6 shows a schematic illustration of the configuration of further driving members, which can be used in the developed dispensing devices;

FIG. 7A shows a schematic perspective view a dispensing device with a first exemplary driving mechanism;

FIG. 7B shows a side view of the configuration of FIG. 7A;

FIG. 8A shows a schematic perspective view of a dispensing device with a second exemplary driving mechanism;

FIG. 8B shows a side view of the configuration of FIG. 8A;

FIG. 9A shows a schematic perspective view of a first exemplary dispensing device configured to be coupled with 2k cartridges;

FIG. 9B shows a top view of the configuration of FIG. 9A;

FIG. 10 shows a top view of a second exemplary dispensing device configured to be coupled with 2k cartridges;

FIG. 11 shows a schematic top view of a third exemplary dispensing device configured to be coupled with 2k cartridges;

FIG. 12A shows a schematic perspective view of a fourth exemplary dispensing device configured to be coupled with 2k cartridges;

FIG. 12B shows a back view of the configuration of FIG. 12A;

FIG. 13A shows a schematic perspective view of a dispensing device with a longitudinally acting driving mechanism;

FIG. 13B shows a side view of the configuration of FIG. 13A;

FIG. 14A shows a first exemplary implementation of the configuration of FIGS. 13A and 13B;

FIG. 14B shows a side view of the configuration of FIG. 14A;

FIG. 15A shows a second exemplary implementation of the configuration of FIGS. 13A and 13B;

FIG. 15B shows a side view of the configuration of FIG. 15A;

FIG. 16A shows a third exemplary implementation of the configuration of FIGS. 13A and 13B;

FIG. 16B shows a side view of the configuration of FIG. 16A;

FIG. 17A shows a fourth exemplary implementation of the configuration of FIGS. 13A and 13B;

FIG. 17B shows a side view of the configuration of FIG. 17A;

FIG. 18A shows a schematic perspective view of a dispensing device with another configuration for the driving mechanism in a first state;

FIG. 18B shows a perspective view of the dispensing device of FIG. 18A with an outer housing and a stand;

FIG. 18C shows an enlarged view of the left portion of FIG. 18A;

FIG. 18D shows a top view of the configuration of FIG. 18C;

FIG. 18E shows a schematic perspective view of the dispensing device of FIGS. 18A to 18D in a second state;

FIG. 18F shows an enlarged view of the left portion of FIG. 18E;

FIG. 18G shows a top view of the configuration of FIG. 18F;

FIG. 18H illustrates the differences between FIG. 18D (on the left) and 18G (on the right);

FIG. 19 shows schematically a configuration similar to the one of FIGS. 18A to 18H but configured to be coupled to 2k cartridges;

FIG. 20 shows schematically a configuration similar to the one of FIGS. 18A to 18H but with an alternative implementation of the guiding means for the driving member;

FIG. 21A shows a schematic perspective view of a dispensing device with another driving mechanism configuration;

FIG. 21B shows a side view of the configuration of FIG. 21A;

FIG. 22A shows a schematic perspective view of a dispensing device with another driving mechanism configuration;

FIG. 22B shows a side view of the configuration of FIG. 22A;

FIG. 23 illustrates schematically a further exemplary configuration of a driving mechanism for the dispensing mechanism;

FIG. 24A shows a schematic side view of a configuration with exemplary anti-drip means in a first state;

FIG. 24B shows the configuration of FIG. 24A in a second state;

FIG. 25A shows a schematic perspective view of a dispensing device with another driving mechanism configuration in a first state;

FIG. 25B shows a side view of the configuration of FIG. 25A;

FIG. 25C shows a first side view of the dispensing device of FIGS. 25A and 25B in a second state;

FIG. 25D shows an opposed second side view of the configuration of FIG. 25C;

FIG. 26A shows a schematic perspective view of a dispensing device with another driving mechanism configuration;

FIG. 26B shows a side view of the configuration of FIG. 26A;

FIG. 27A shows a schematic partial perspective view of a dispensing device with exemplary connection means for a cartridge;

FIG. 27B shows a cross-sectional side view of the configuration of FIG. 27A;

FIG. 28A shows a schematic perspective view of a dispensing device with a telescopically extendable frame configuration in a first state;

FIG. 28B shows a side view of the configuration of FIG. 28A in the first state;

FIG. 28C shows a schematic perspective view of the configuration of FIG. 28A in a second state;

FIG. 28D shows a side view of the configuration of FIG. 28C;

FIG. 29 illustrated an undesired lifting-off process which could occur upon retraction forces acting on the plunger;

FIG. 30A shows a schematic perspective view of a dispensing device with guiding means according to a first exemplary configuration;

FIG. 30B shows a side view of the configuration of FIG. 30A;

FIG. 31 shows a schematic perspective view of a dispensing device with guiding means according to a second exemplary configuration;

FIG. 32 shows a schematic perspective view of a dispensing device with guiding means according to a third exemplary configuration;

FIG. 33 shows a schematic perspective view of a dispensing device with guiding means according to a fourth exemplary configuration;

FIG. 34A shows a schematic perspective view of a dispensing device according to a further exemplary configuration;

FIG. 34B shows a side view of the configuration of FIG. 34A; and

FIG. 34C shows a rear view of the configuration of FIG. 34A.

### DETAILED DESCRIPTION

Throughout the various figures, identical reference signs denote corresponding components (at least in function).

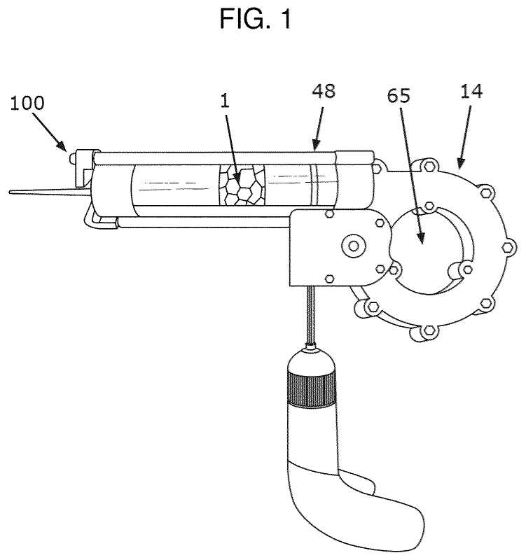

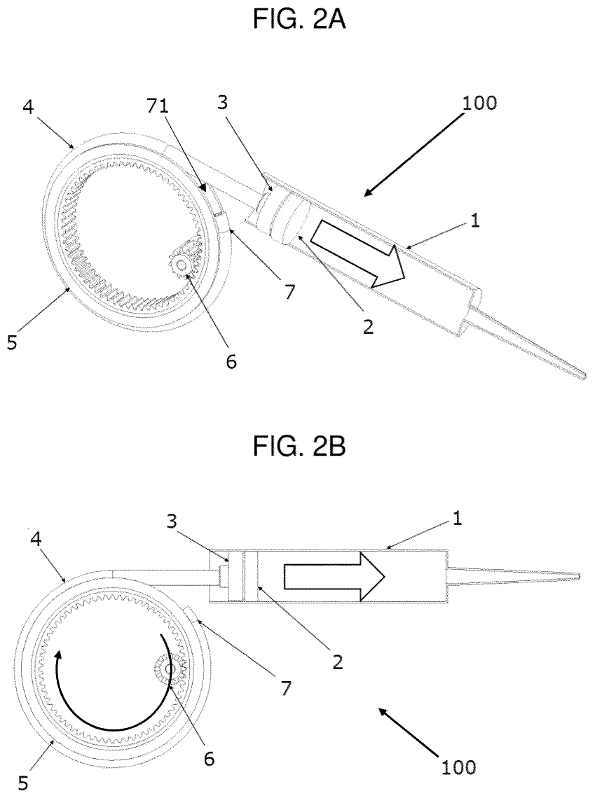

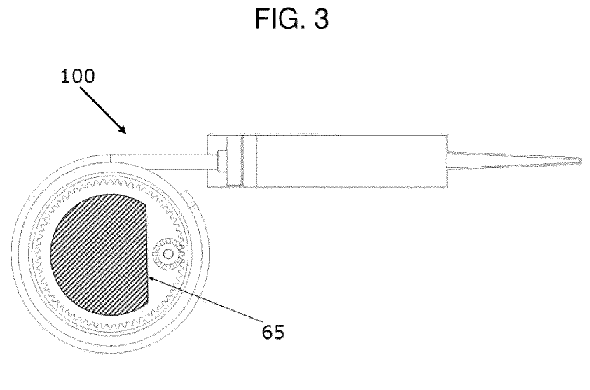

As can be seen in FIG. 1 showing a photo of an exemplary prototype of a dispensing device 100 developed in conjunction with the present disclosure. The dispensing device 100 comprises a base structure 48 configured to hold a cartridge 1, a driving mechanism (here with a battery-powered screw-driver as a motor) configured to cause a dispensing movement of a plunger 3 (not visible here; see for example FIGS. 2A and 2B) along the base structure 48 through the cartridge 1, and a driving member 4 (not visible here; see for example FIGS. 2A and 2B) configured to transmit driving force from the driving mechanism to the plunger 3. The driving member 4 is enclosed by a shaft housing 14 guiding a movement of the driving member 4 and forming a central opening 65 (see also FIG. 3) allowing a user to hold the dispensing device 100 by grapping through the opening 65.

In the following, the internal structure and functionality of the dispensing device 100 of FIG. 1 will be described with reference to FIGS. 2A and 2B.

The dispensing device 100 comprises a circular driving spool 5 coupled to the base structure 48 (not illustrated here) in a rotatable manner. The driving member 4 is provided in a bendable manner and wrapped around the driving spool 5 at least partly. A first end of the driving member 4 is firmly connected to the plunger 3 and the second end of the driving member 4 is firmly connected to the driving spool 5, in particular to a shaft plug 7 fixed to the driving spool 5. The plunger 3 is configured to push a piston 2 of the cartridge 1 through the cartridge 1 for dispensing the material from the cartridge 1.

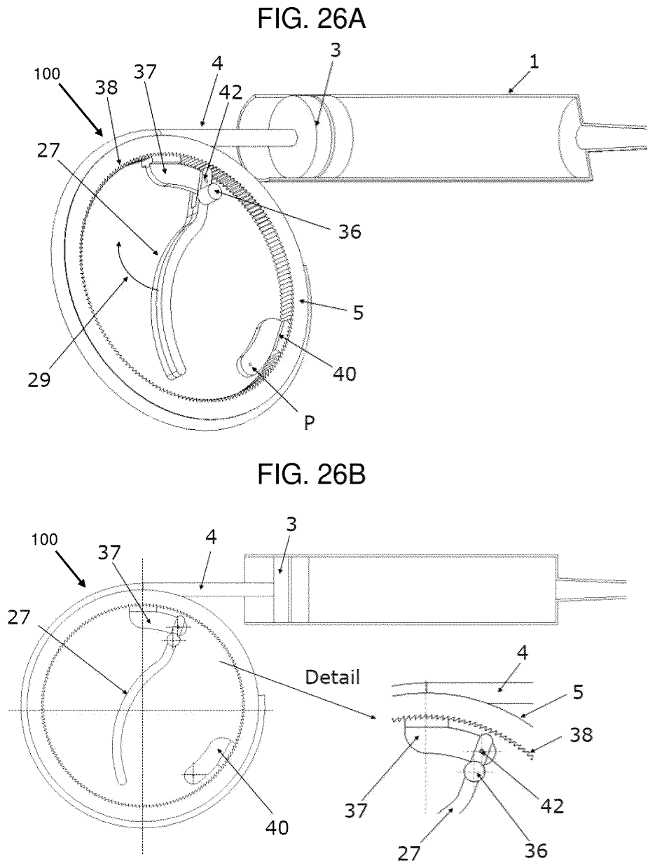

In the illustrated embodiment, the driving spool 5 comprises an inner circumferential surface with gear teeth engaging a pinion gear 6 for driving the driving spool 5. Alternatively, the gear teeth can be provided on an outer circumferential surface or on side surface of the driving spool 5, or can be replaced by ratchet teeth engaged by a ratchet or pawl means 37 (described below with respect to FIGS. 26A and 26B) for driving the driving spool 5.

With this configuration, a rotational movement of the pinion gear 6 causes a rotational movement of the driving spool 5 (see the small arrow in FIG. 2B) resulting in an unwrapping of the driving member 4 from the driving spool 5. This unwrapping of the driving member 4 generates a translational axially directed force onto the plunger 3 resulting in a translational dispensing movement of the plunger 3 and, thus, of the piston 2 with respect to the base structure 48 through the cartridge 1 (see the big arrows in FIGS. 2A and 2B).

For ensuring that the driving member 4 is not slipping sideways from the driving spool 4 upon reaction forces during the dispensing process, the dispensing device 100 comprises guiding means in the form of a guiding recess 71 on the outer circumferential surface of the driving spool 5 accommodating the driving member 4 at least partially (see FIG. 2A). Other configurations for such guiding means are described further below with respect to FIGS. 29 to 33.

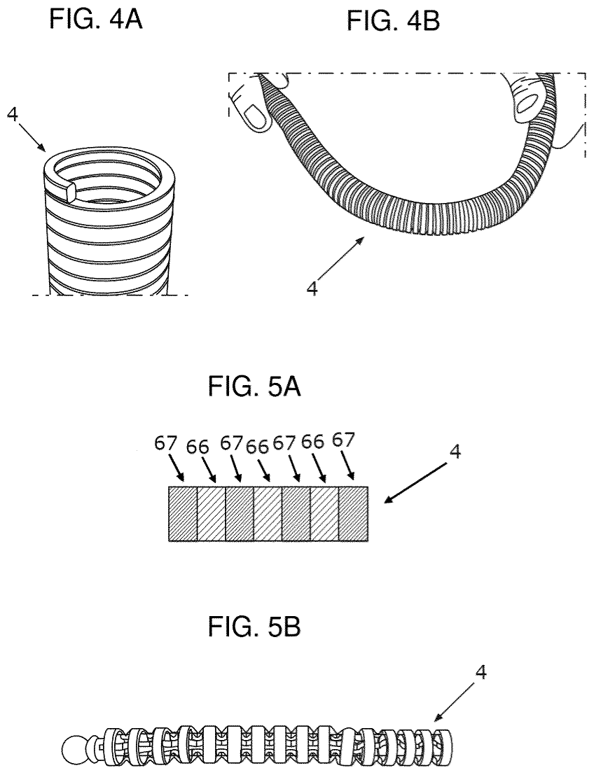

The driving member 4 is configured to transmit driving force from the driving mechanism onto the plunger 3 and can have various configurations. Some exemplary configurations will be described in the following in view of FIGS. 4A to 6.

In general, the driving member 4 is to be configured to transmit a translational force while being bendable about corners or spools for forming compact overall configurations.

To meet these requirements, the driving member 4 can be formed as continuous coil of spring steel as illustrated in FIGS. 4A and 4B. The coil is preferably formed of a wire with an essentially square cross section (see the cutting surface of FIG. 4A). The wire can have a thickness corresponding to the pitch of the formed coil such that the coil can form a tube with a closed outer surface when aligned longitudinally as illustrate din FIG. 4A. For compact and still robust configurations, it has been shown that a coil with a diameter of 10 mm to 25 mm, preferably with a diameter of 13 mm to 22 mm, for example a commercially available spring with a diameter of 13.5 mm respectively of 22 mm, is to be preferred. With this specific configuration of the driving member 4, the driving member can transfer forces longitudinally along the driving member 4 but can be guided/bent, for example about a driving spool 5 as illustrated in FIGS. 2A and 2B.

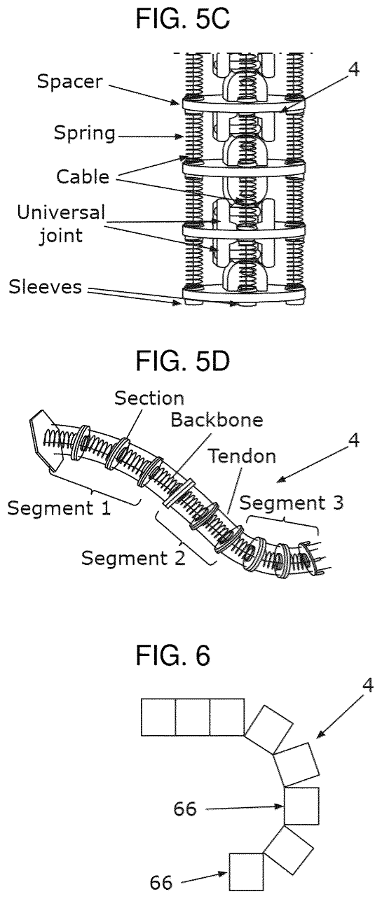

Alternatively, the driving member 4 can be formed from alternating first components of flexible material 66 and second components of rigid material 67 (see FIG. 5A) coupled to each other to form a configuration being configured to transmit lateral forces along its length but to bend upon transversal forces acting thereon. In particular, the driving member 4 can be formed of multiple essentially identical segments connected to each other in a non-releasable as illustrated in FIGS. 5B to 5D. Each of the segments can comprise at least one, preferably multiple, spring members acting as flexible components 66, spacers, in particular spacer plates acting as rigid components 67 and/or joint members for coupling the flexible and rigid components 66 and 67 of the segments and/or different segments to each other.

According to a further exemplary configuration, the driving member 4 can be formed of various rigid components 67 each connected one after another to one common elongated flexible, in particular bendable, component 66 as it is illustrated in FIG. 6.

To ensure that such at least partly flexible diving members 4 follow a desired movement path and do not flex out upon a specific reaction forces as it is illustrated for example in FIG. 29, the dispensing device 100 can be provided with various guiding means.

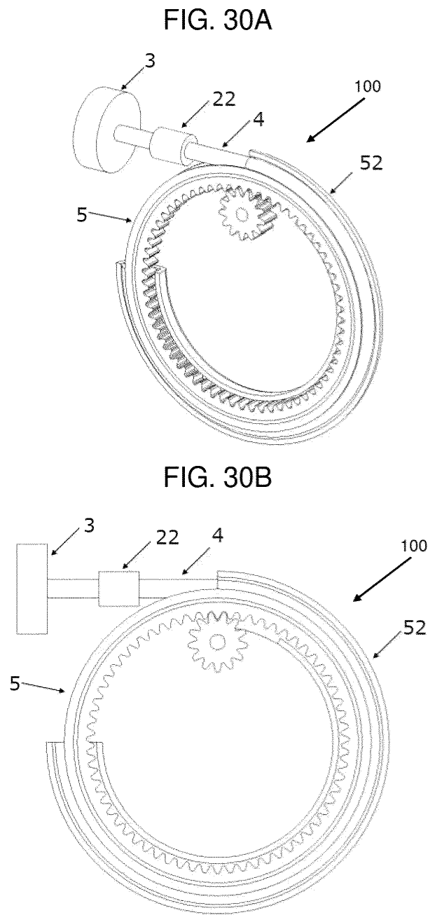

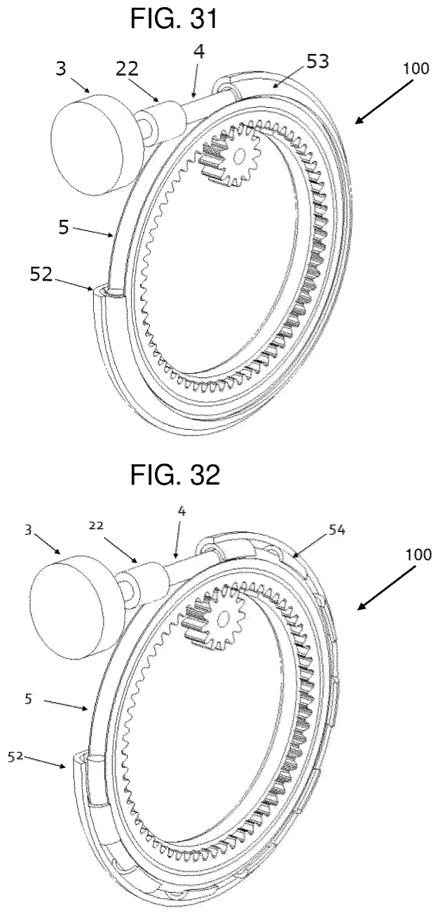

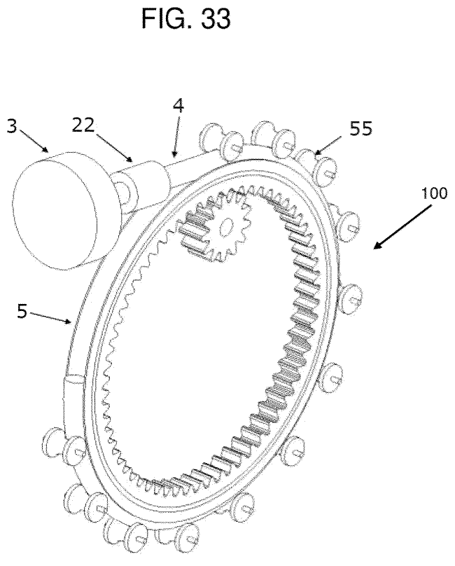

As indicated above, such guiding means can be in the form of a guiding recess 71 along the driving spool 5 for preventing a lateral slipping-off of the flexible driving member 4. For preventing the radial lifting-off illustrated in FIG. 29, the dispensing device 100 can be provided with at least one clamshell 52 as illustrated in FIGS. 30A and 30B, or at least one low friction plate 53 as illustrated in FIG. 31, at least one, in particular multiple, low friction inserts 54 as illustrated in FIG. 32, and/or at least on, in particular multiple, rollers 55 as illustrated in FIG. 33.

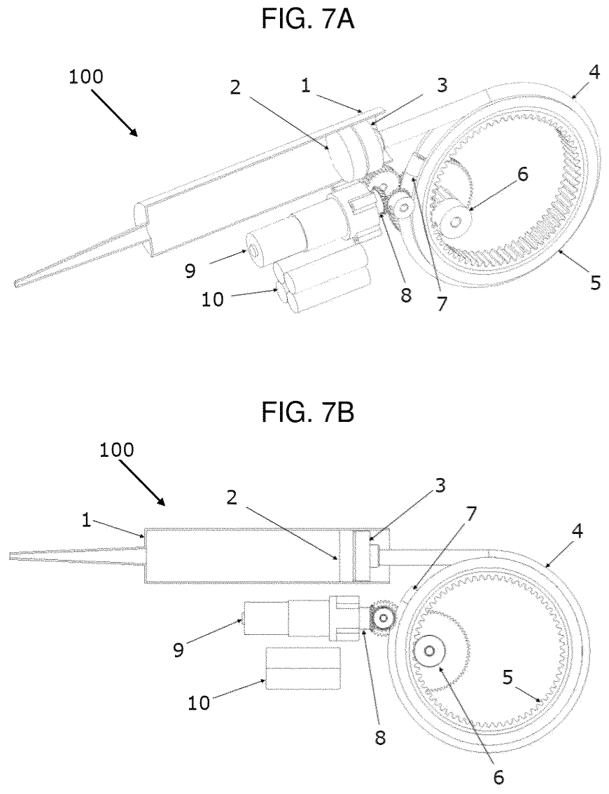

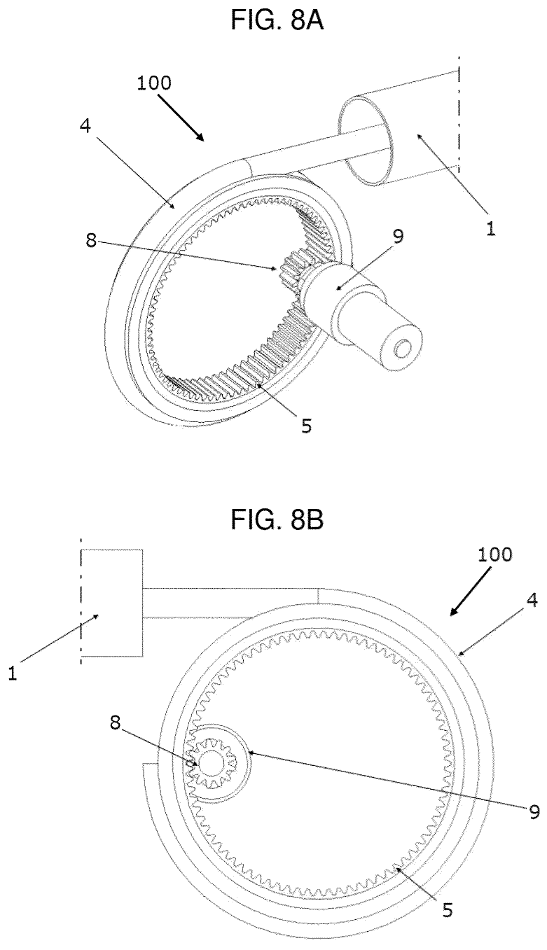

Similar to the configuration of the prototype of FIG. 1, the dispensing device 100 can be an electrically driven, in particular cord-less, to form a handheld device. For this, the driving mechanism 100 can be provided with a motor gear-box 9, as for example illustrated in FIG. 7A to FIG. 8B.

Referring to FIGS. 7A and 7B, the motor gearbox 9 can be provided in parallel with the longitudinal axis of the cartridge 1 to form a configuration with low width. Alternatively, the longitudinal axis of the motor gearbox 9 can be perpendicular with the longitudinal axis of the cartridge 1 to enable a more direct transfer of output forces from the motor gearbox 9 on the driving spool 5 (see FIGS. 8A and 8B).

For transferring an output force from the motor gearbox 9 to the driving spool 5, a motor output gear 8 of the motor gearbox 9 can be engaged directly with the driving spool 5 as illustrated in FIGS. 8A and 8B. Alternatively, at least one, preferably multiple, of spur gears, compound gears, bevel gears, worms, wheels, belt drives, chains, sprockets and/or friction wheels can be provided for connecting a motor output gear 8 of the motor gearbox 9 to a pinion gear 6 engaged with the driving spool 5 (see FIGS. 7A and 7B).

As illustrated further in FIGS. 7A and 7B, the dispensing device 100 can be provided with batteries 10 (in particular combined to a battery pack) for energizing the motor gearbox 9. Alternatively, an energy storage for energizing the motor gearbox 9 can be integrated directly into the motor gearbox 9 as illustrated for example in FIGS. 8A and 8B.

By way of example, the energy storage of FIGS. 8A and 8B could also be provided in the form of a battery 10. Such a battery 10 or energy storage could be arranged in parallel to the motor axis on or beneath the cartridge 1 in a manner similar to an arrangement that could be chosen in connection with the dispensing device 100 of FIGS. 7A and 7B.

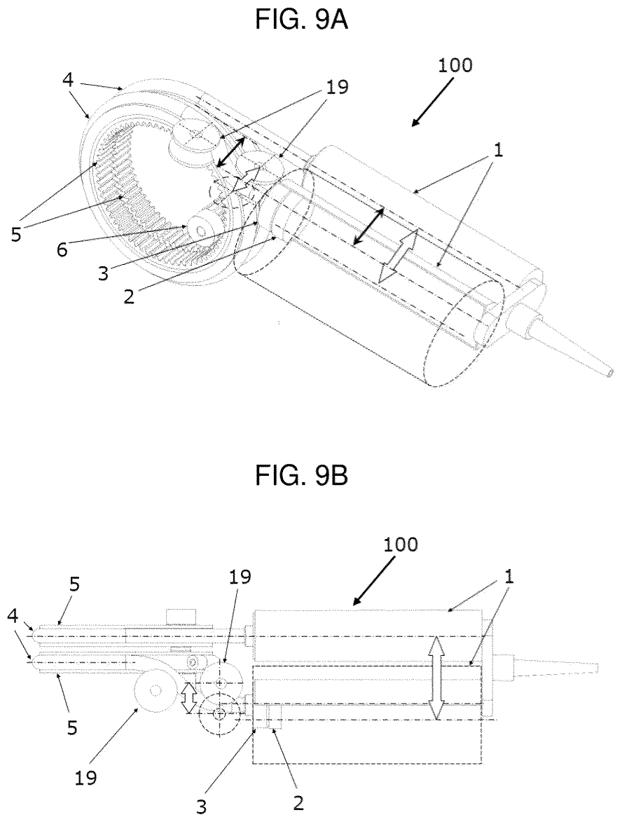

In the following, with reference to FIGS. 9A to 12B, various configurations allowing to connect 2k cartridges 1, in particular of different width, in parallel to each other in a fixed but releasable manner to the base structure 48 of the dispensing device 100 will be described.

In such configurations, the dispensing device 100 comprises preferably one separate plunger 3 and one separate driving member 4 for each cartridge 1 but only one common driving mechanism. Each of the driving members 4 is provided on its own driving spool 5 (forming parts of the common driving mechanism). The driving spools 5 are driven by at least one pinion gear 6 connected to one common motor gearbox 9 (not illustrated here) to form one common driving mechanism for the two driving members 4.

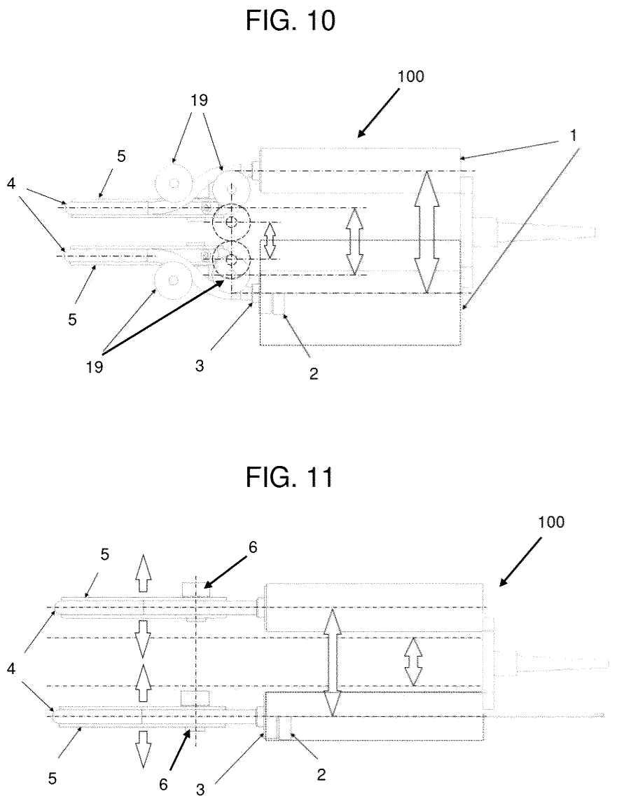

To allow a variation of the lateral positioning of the 2k cartridges 1, such that cartridges 1 with varying width can be connected to the dispensing device 100 reliably, the dispensing device 100 can be provided with guiding means like guide wheels 19 guiding the driving members 4 (see FIGS. 9A to 10). To implement the variable position adjustments of the 2k cartridges 1, only one of the two driving members 4 can be provided with such guide wheels 19, of which the last one is movable in the lateral direction (see the arrows in FIGS. 9A and 9B). For more flexibility and even greater adjustability, both driving members 4 can be guided by such laterally movable guide wheels 19, as it is illustrated in FIG. 10. The guide wheels 22 could be replaced or supplemented by guide bushes 22.

Alternatively, the dispensing device 100 can be provided with adjusting means for varying a lateral distance between the separate components for dispensing the material from the 2k cartridges 1 as schematically illustrated in FIG. 11. Here, the driving members 4 and the corresponding driving spools 5 are provided laterally displaceable with respect to each other (see the arrows). Each of the driving spools 5 is engaged with its own pinion gear 6, wherein both pinion gears 6 are connected, for example via a common splined drive shaft (not illustrated) to the common motor gearbox 9 (not illustrated).

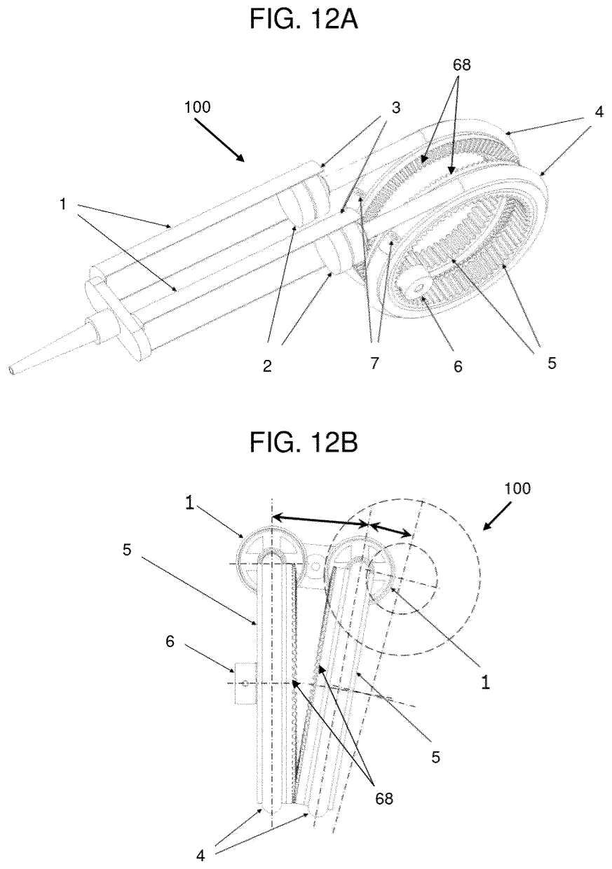

Alternatively, dispensing device 100 can be provided with adjusting means for varying an orientation between the separate components for dispensing the material from the 2k cartridges 1 as schematically illustrated in FIGS. 12A and 12B. Here, the two driving spools 5 are tilted with respect to each other by a variable angle but engaged with each other via a direct teethed engagement of lateral gear circles 68. The variable angle goes for example from 0° to 90°, in particular to 60° or merely to 45°. Thus, only one (here the left one) of the two driving spools 5 has to be connected via a pinion gear 6 to the motor gearbox 9 (not illustrated here). Alternatively, each of the driving spools 5 can be engaged with its own pinion gear 6, wherein both pinion gears 6 are connected to each other via a universal joint (not illustrated).

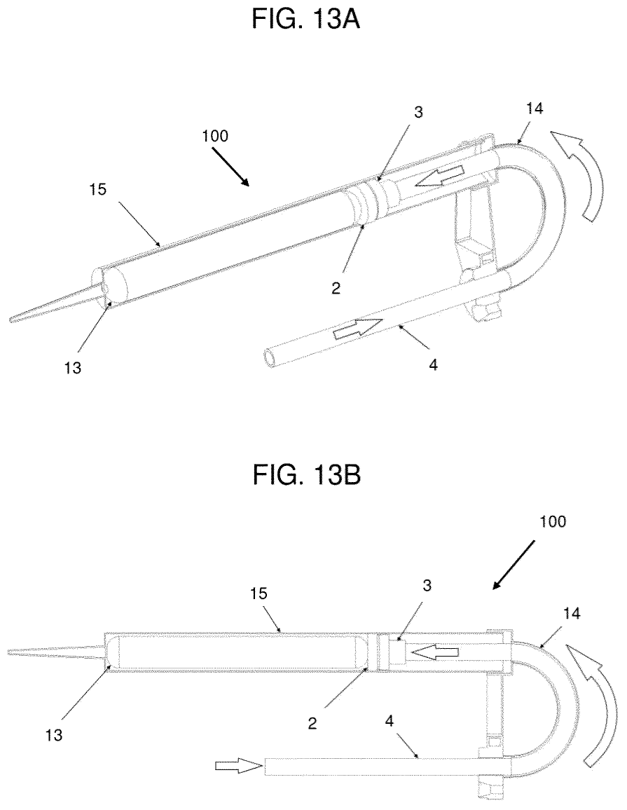

As indicated above in view of FIG. 1 for a configuration with a driving spool 5 and illustrated in FIGS. 13A and 13B for a configuration without such a driving spool, the driving member 4 can be guided through a shaft housing 14 defining a curved, in particular partly circle-shaped, path for directing a movement direction of the driving member 4. A radius of the driving spool 5 can be for example in the range of 5 cm to 25 cm, especially of 10 cm to 20 cm and in particular of 16 cm.

In the following, exemplary implementations for driving mechanisms of dispensing devices 100 without a driving spool 5 and with the moving characteristics for the driving member 4 as indicated in FIGS. 13A and 13B will be described.

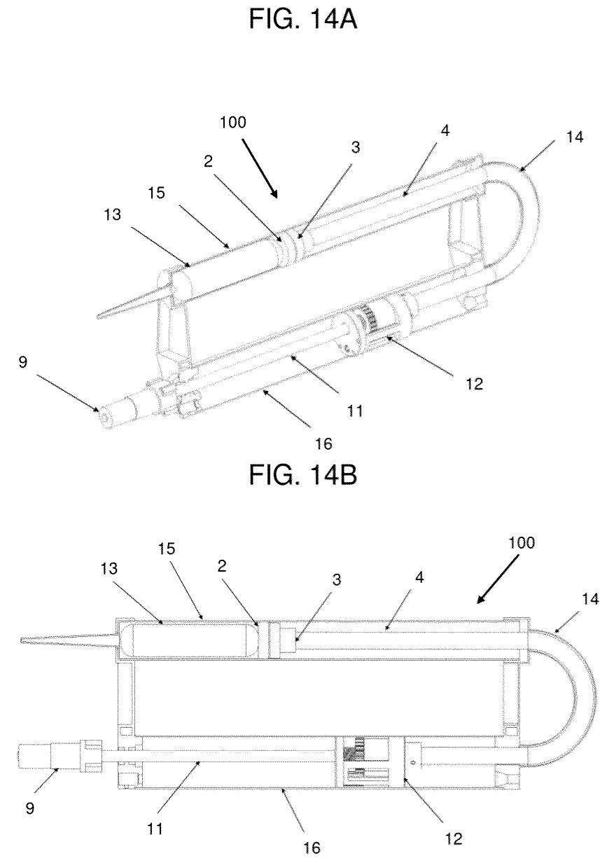

As illustrated for example in FIGS. 14A and 14B, the driving mechanism can comprise a motor gearbox 9 connected to a drive shaft 11 threadedly engaged with a drive carriage 12 fixed to the driving member 4. The drive carriage 12 is hold non-rotatably (in particular by longitudinal guide protrusions engaged with corresponding guide recesses) but axially movably inside a retaining tube 16. This configuration results in the conversion of a rotational driving force from the motor gearbox 9 into a translational pushing force on the driving member 4. The translational pushing force is redirected by the shaft housing 14 before acting via the plunger 3 on the piston 2 within the cartridge 1, as indicated by the arrows in FIGS. 13A and 13B.

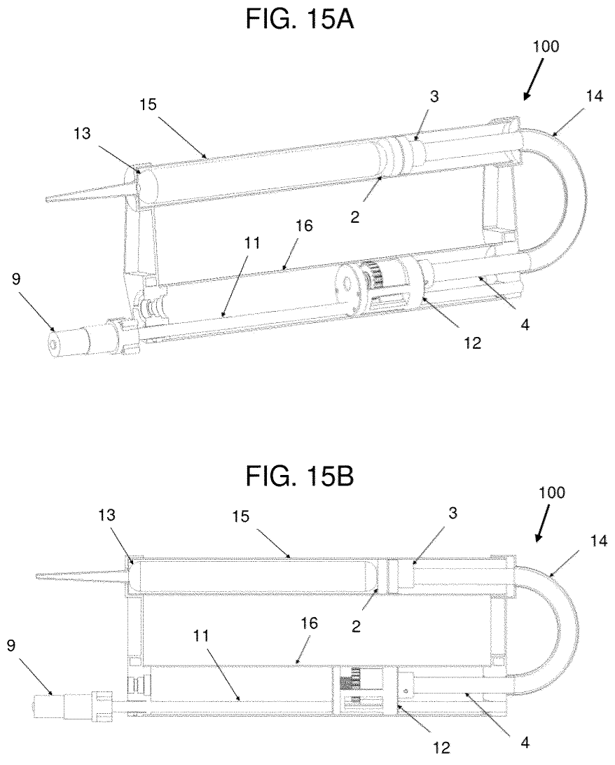

The threaded drive shaft 11 can be provided in such a manner that an end section thereof projects into a rear end section of the driving member 4 as illustrated in FIGS. 14A and 14B, or that the end section is positioned in parallel but displaced with respect to the rear end section of the driving member 4 as illustrated in FIGS. 15A and 15B.

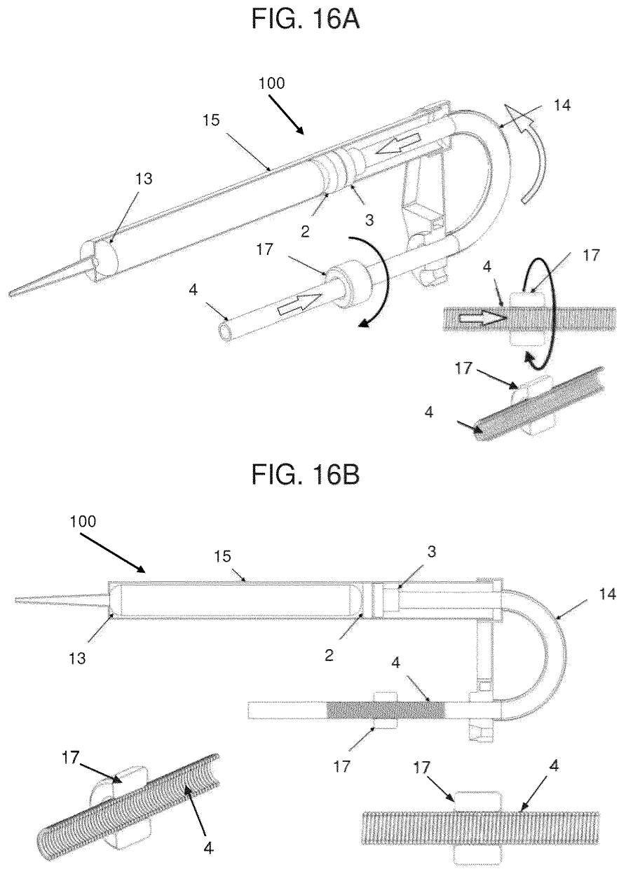

Alternatively, the driving member 4 can be configured to define an external threaded structure engaged with a threaded collet 17 of the driving mechanism, as illustrated in FIGS. 16A and 16B. The threaded collet 17 is coupled in an axially fixed but rotatable manner to a retaining tube 16 (not illustrated here) similar to the retaining tube 16 of FIGS. 14A to 15B, such that a rotational movement of the threaded collet 17 causes a translational movement of the driving member 4.

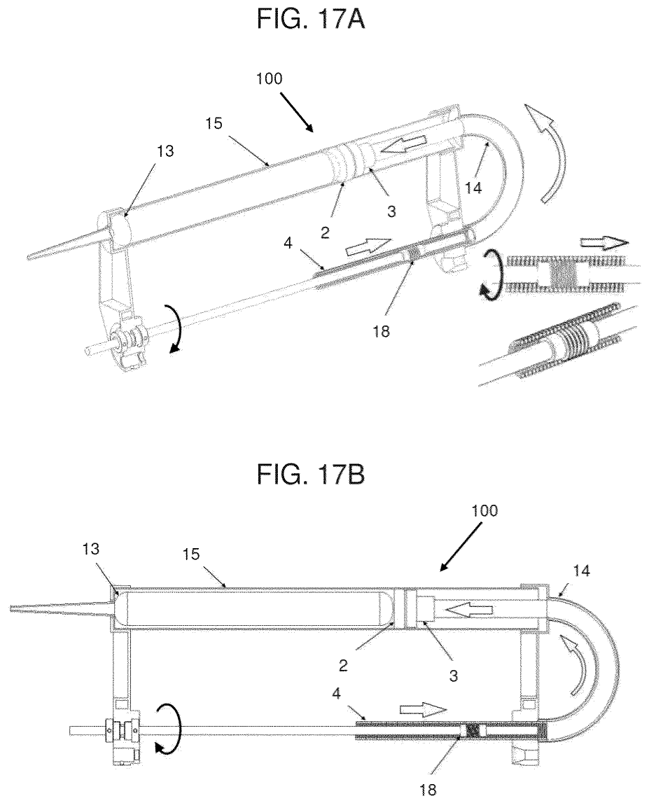

Further alternatively, the driving member 4 can be configured to define an inner threaded structure engaged with a threaded spindle 18 connected to a motor gearbox 9 (not illustrated here) for converting the rotational driving force from the motor gearbox 9 into a translational driving movement of the driving member 4 (see FIGS. 17A and 17B).

In this connection, it is pointed to the fact that the developed dispensing devices 100 are compatible with simple cartridges 1 provided merely with a piston 2 as illustrated for example in FIGS. 2A to 3, 7A and 7B and cartridges 1 formed by a barrel 15 in which a sachet 13 filled with the material to be dispensed and a piston 2 are provided (see FIGS. 13A to 17B).

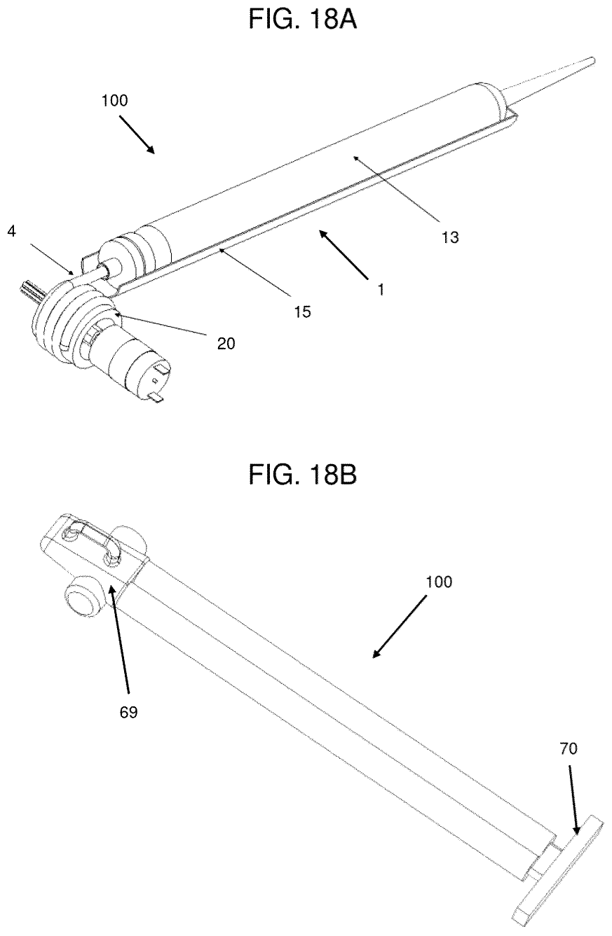

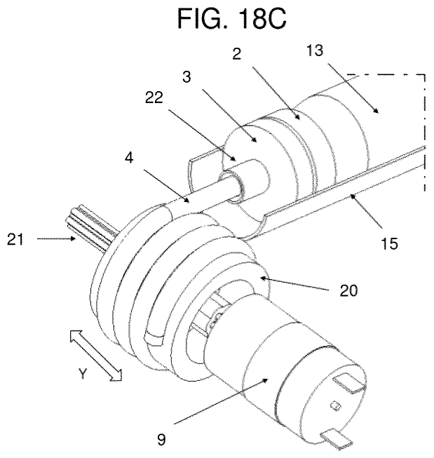

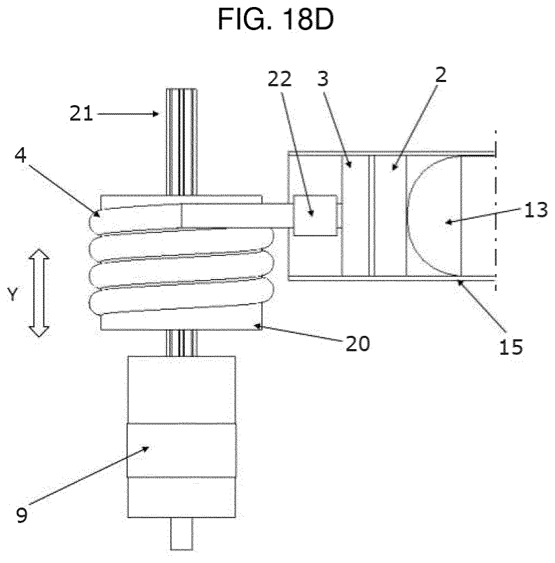

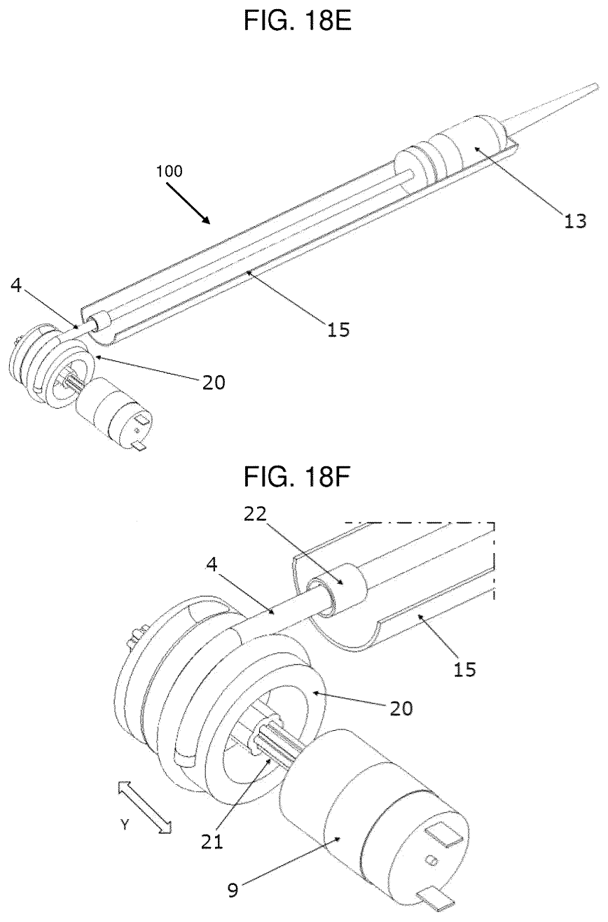

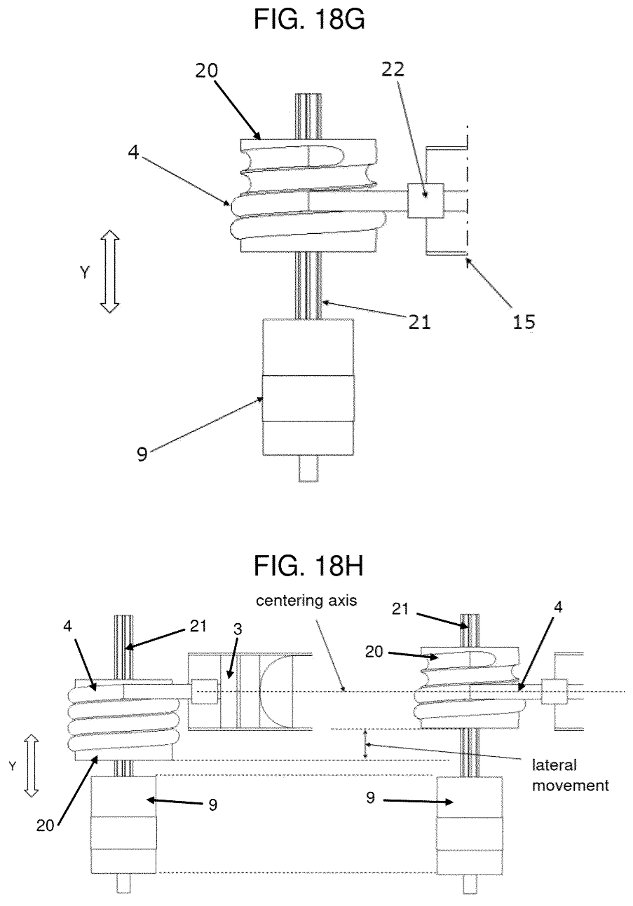

In the following, various configurations for dispensing devices 100 for comparatively big cartridges 1, in particular for floor dispensing devices 100, will be described with reference to FIGS. 18A to 20.

As can be seen in FIG. 18A, such configurations are preferably used with cartridges 1 with a barrel 15 enclosing a sachet 13 filled with the material to be dispensed. FIG. 18B shows an exemplary perspective view of such a dispensing device 100 provided with an outer housing 69 and a stand 70.

Referring to FIGS. 18C and 18D, the driving member 4 of such a dispensing device 100 can be provided on (in particular wrapped multiple times around) a support member 20 in the form of a rod drum. The driving member 4 is guided through guiding means in the form of a guide bush 22 for centering an end of the driving member 4 acting on the plunger 3, on the plunger 3. The illustrated support member 20 is provided rotationally fixed but translationally movable on a splined shaft 21 connected rotatably to a motor gearbox 9. Thus, the motor gearbox 9 can rotate the support member 20 to cause the above described unwrapping dispensing movement of the driving member 4.

The guide bush 22 is provided in a fixed position with respect to the cartridge 1 coupled to the dispensing device 100 such that upon a rotational unwrapping movement of the driving member 4 from the support member 20, the support member 20 moves translationally in a direction Y perpendicular with respect to the intended movement direction of the plunger 3. This centering movement can be seen when comparing FIGS. 18A, 18C and 18D showing the dispensing device 100 in a first initial state, with FIGS. 18E to 18G showing the dispensing device in a second final state after conducting a dispensing operation. FIG. 18H shows a direct comparison of FIGS. 18D (on the left) and 18G (on the right) for clarifying the described movement of the support member 20 in the direction Y during the dispensing process for keeping the first end of the driving member 4 connected to the plunger 3 centered.

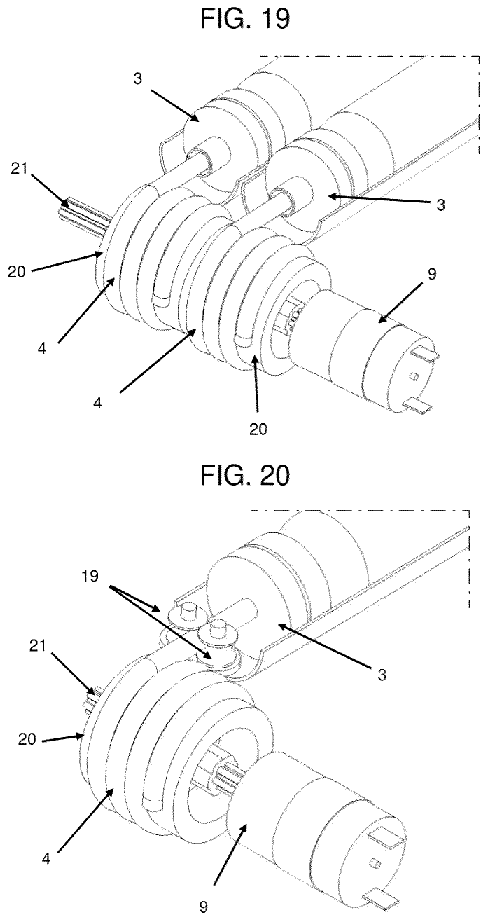

Referring to FIG. 19, it is pointed to the fact that a second support member 20 with a second driving member 4 guided through a second guide bush 20 for dispensing material from a second cartridge 1, respectively a collapsible cartridge, coupled to the dispensing device 100 can be connected in parallel with the first support member 20 described above to the single splined shaft 21 and, thus, to the one single motor gearbox 9. Thus, a configuration allowing a simultaneous dispensing process of material from 2k cartridge 1 connected to one single dispensing device 100.

As illustrated in FIG. 20, the guide bush(es) 20 can be replaced by a pair of guide wheels 19 for centering the first end of the driving member 4.

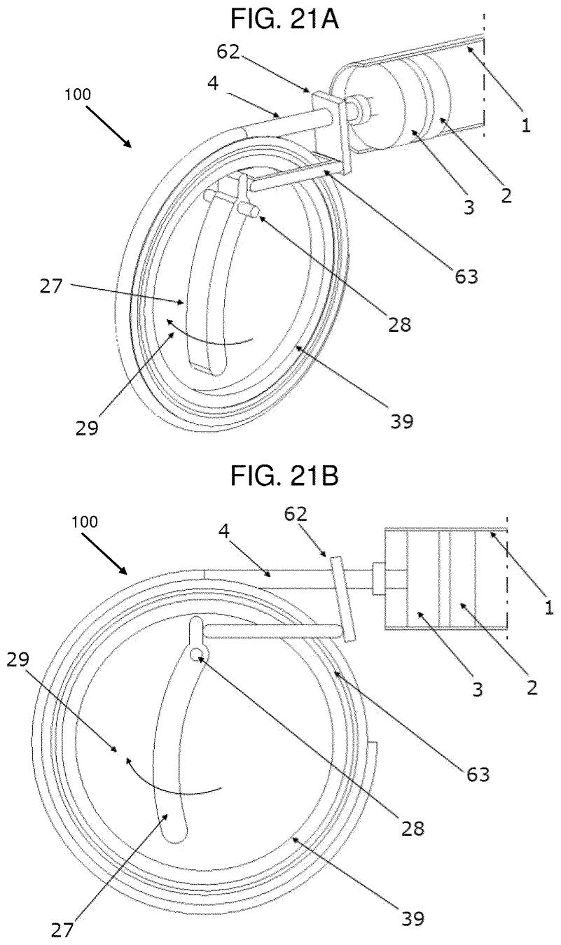

FIGS. 21A and 21B show a further configuration for a dispensing device 100 with a driving member 4 wrapped around a spool 39, similar to the driving spool 5 described above with reference to FIGS. 7A and 7B.

However, the herein illustrated configuration is not driven electrically via a motor gearbox 9 coupled to a driving spool 5, but manually via a catch plate drive for driving the driving member 4 directly. The catch plate drive comprises trigger 27 supported pivotably on a trigger axis 28 for enabling a trigger rotation 29. The trigger 27 is coupled via a link 63 to a catch plate 62 gripping the driving member 4 near the plunger 3. A pulling force on the trigger 27 for causing the indicated trigger rotation 29 results in a pushing force on the driving member 4 and, thus, via the plunger 3 onto the piston 2 of the cartridge 1. Although not illustrated here, the catch plate drive can be provided with a resetting spring (not illustrated), in particular acting on the catch plate 62, for resetting the catch plate drive after releasing the trigger 27. Thus, the material from the cartridge 1 can be dispensed via a manual “pumping” operation of the trigger 27. During this dispensing operation, the spool 39 rotates passively to not block the unwrapping movement of the driving member 4 from the spool 39.

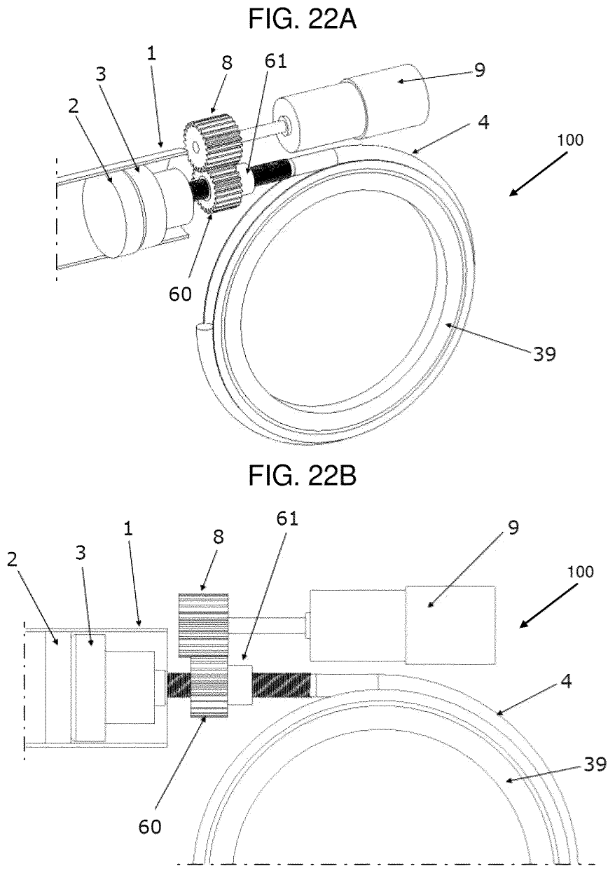

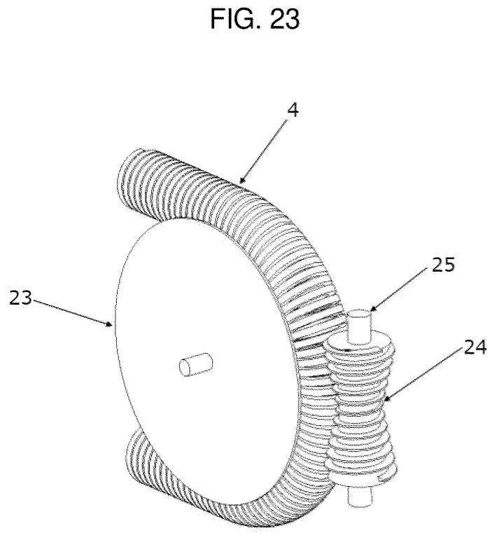

In a hereto alternative configuration in which not the spool 39 but the driving member 4 itself is driven, the driving mechanism can comprise a nut drive with a drive nut 60 and a thrust bearing 61, acting directly on the driving member 4 via a threaded engagement for converting a rotational movement of the drive nut 60 and the thrust bearing 61 into a translational movement of the driving member 4. To form an electrically driven configuration, the drive nut 60 can be in teethed engagement with a motor output gear 8 of an electric motor gearbox 9 as it is illustrated in FIGS. 22A and 22B.

Instead of the above described nut drive coupled to the plunger-side section of the driving member 4, the driving mechanism can comprise a rotary worm drive with a worm gear 24 supported rotatably on a worm gear axle 25 as illustrated in FIG. 23. The worm gear 24 is threadedly engaged with a bended mid-section of the driving member 4 for converting a rotational movement of the worm gear 24 into a translational movement of the driving member 4.

In view of FIG. 23, it is pointed to the fact that the above described driving spool 5 with a central opening 65 can be replaced by an idler pulley 23 without the central opening 65 for griping the dispensing device 100, if desired.

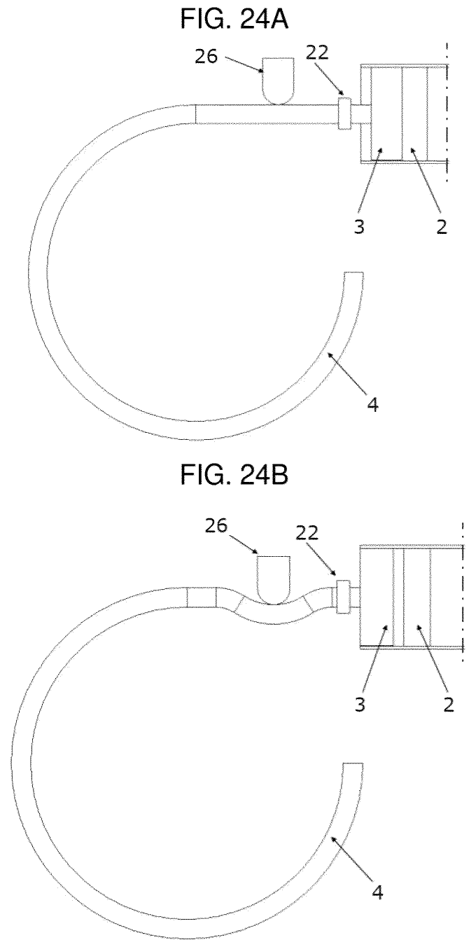

The above described configurations can be provided with an anti-drip means as exemplarily described in the following with respect to FIGS. 24A and 24B.

Here, the anti-drip means is implemented as anti-drip finger 26 configured to be operated by a user to release the pressure applied by the driving member 4 via the plunger 3 onto the piston 2. This releasing is caused in the illustrated embodiment by a small reverse movement of the end section of the driving member 4 connected to the plunger 3 from a dispensing position in which the plunge 3 contacts the piston 2 (see FIG. 24A) to a release position, in which the plunger 3 does not contact the piston 2 anymore (see FIG. 24B). Thus, any remaining pressure applied by the driving mechanism 4 via the plunger 3 on the piston 2 is released. To prevent a misalignment of the driving member 4 and/or sheering forces onto the plunger 3 when activating (i.e. pushing down) the anti-drip finger 26, guiding means in the form of a guide bush 22 are provided around the driving member 4 between the anti-drip finger 26 and the plunger 3.

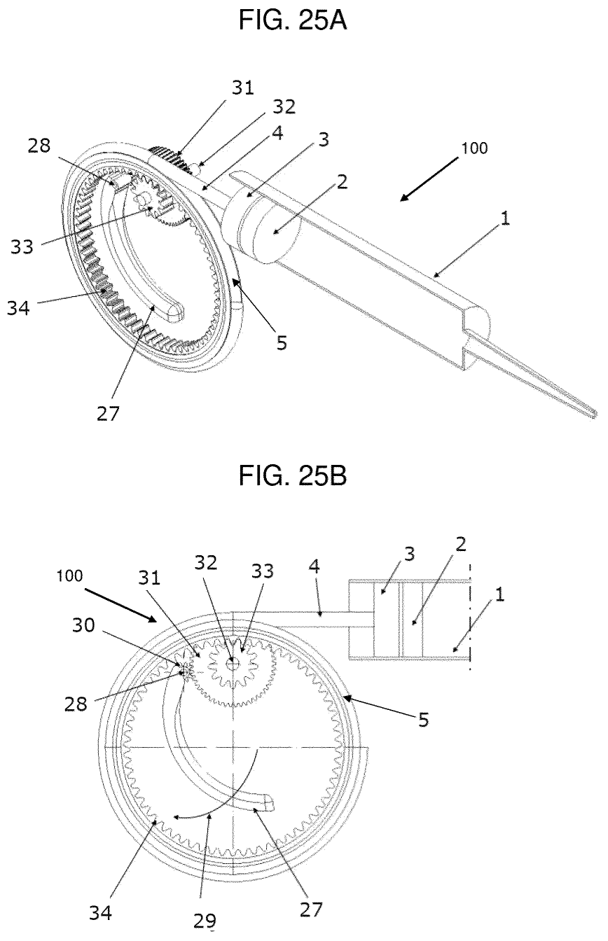

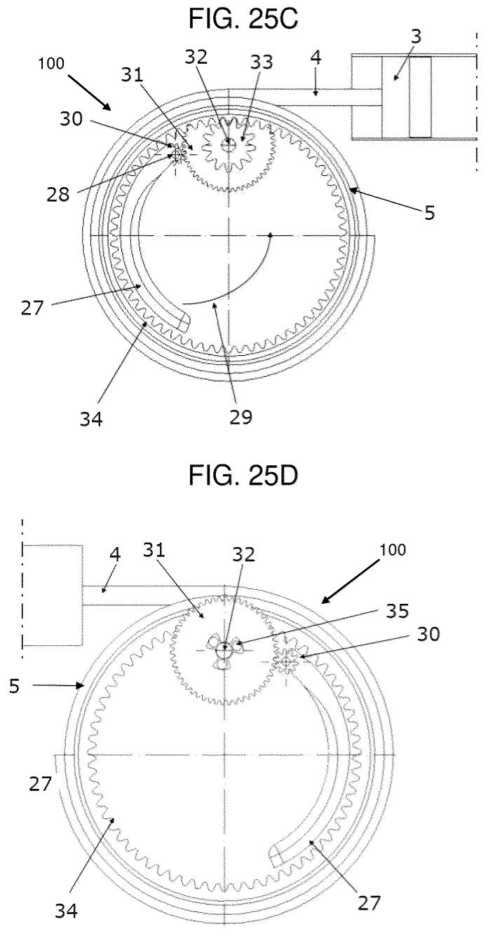

FIGS. 25A to 25D show a further manually driven configuration. The configuration comprises a manually driven gear drive with a trigger 27 supported pivotably on a trigger axis 28 (similar to the configuration described above with respect to FIGS. 21A and 21B). The trigger 27 is provided with a trigger gear 30 engaged with a trigger driven gear 31. The trigger driven gear 31 is coupled via a one-way clutch 35 to an anulus drive gear 33 provided on an anulus drive gear axle 32 oriented in parallel with the trigger axis 28. The anulus drive gear 33 is engaged with an anulus gear 34 formed along the inner circumference of the driving spool 5.

A trigger rotation 29 in the direction indicated in FIG. 25C causes a rotation of the driving spool 5 and, thus, in the above described unwrapping movement of the driving member 4. During a trigger rotation 29 in the reverse direction indicated in FIG. 25B, the one-way clutch 35 is decoupled such that no rotation of the driving spool 5 is generated. For causing this resetting movement automatically on releasing the trigger 27, the trigger 27 can be coupled to a resetting spring (not illustrated).

According to a further alternative, a manually driven configuration can comprise a manually driven ratchet drive as exemplarily illustrated in FIGS. 26A and 26B. Here, the ratchet drive comprises a trigger 27 connected to a trigger pivot 36. The trigger 27 is connected via a drive pawl pivot 42 to a drive pawl 37 engaged with spool ratchet teeth 38 of the driving spool 5 carrying the driving member 4. In the illustrated implementation, a trigger rotation 29 in the direction indicated in FIG. 26A results in an unwrapping rotation (in the clockwise direction) of the driving spool 5.

To prevent an undesired wrapping rotation (in the counter-clockwise direction) of the driving spool 5 in a state in which the drive pawl 37 is disengaged from the spool ratchet teeth 38 during a resetting movement of the trigger 27, a brake pawl 40 supported on a brake pawl pivot P can be provided.

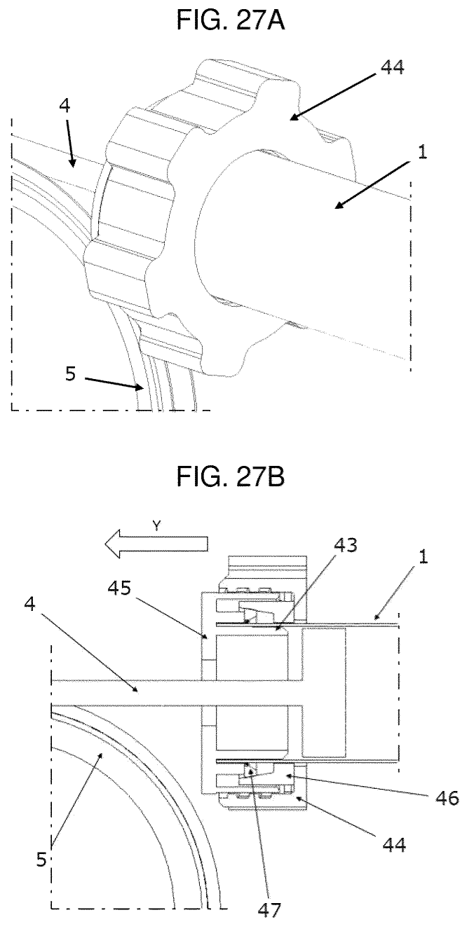

Referring to FIGS. 27A and 27B, the base structure 48 can comprises connection means for connecting a rear end of the cartridge 1 firmly but releasably to the dispensing device 100. The illustrated connection means comprises a dispenser body 45 with a support boss 43 configured to be engaged with a rear portion of the cartridge 1. Furthermore, the connection means comprises a gripping ring 47 compressed between a tapered disk 46 and a ring-shaped protrusion of the dispenser body 45. A locking collar 44 is threadedly engaged with the dispenser body 45 and configured to push the tapered disk 46 onto the gripping ring 47 for fixing the rear portion of the cartridge 1 within the connection means. As can be seen in FIGS. 27A and 27B the support structure 48 with such a connection means can have a length considerably shorter than the length of the cartridge 1.

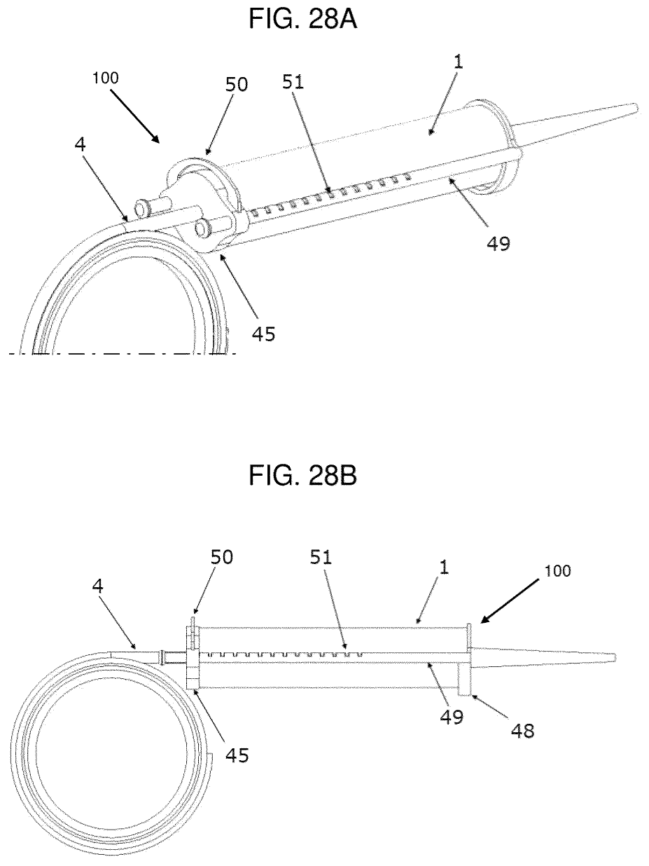

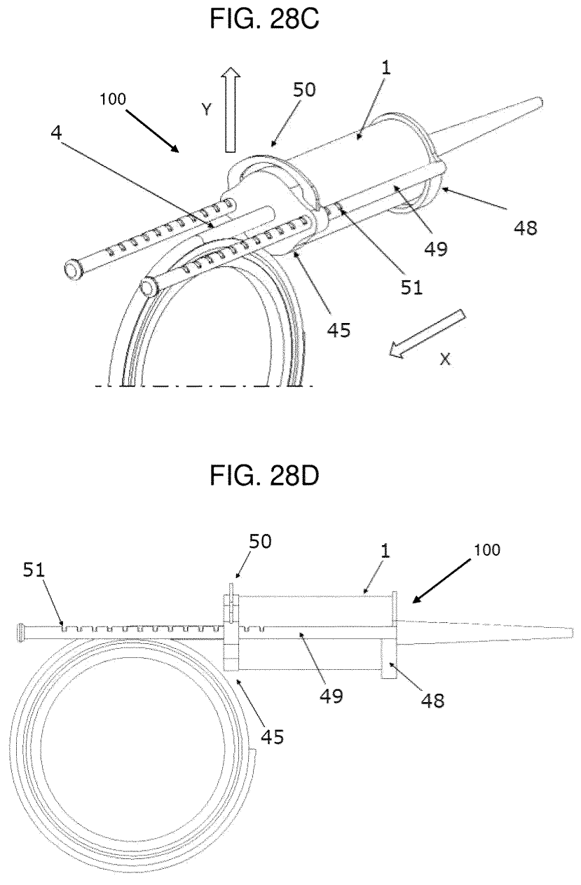

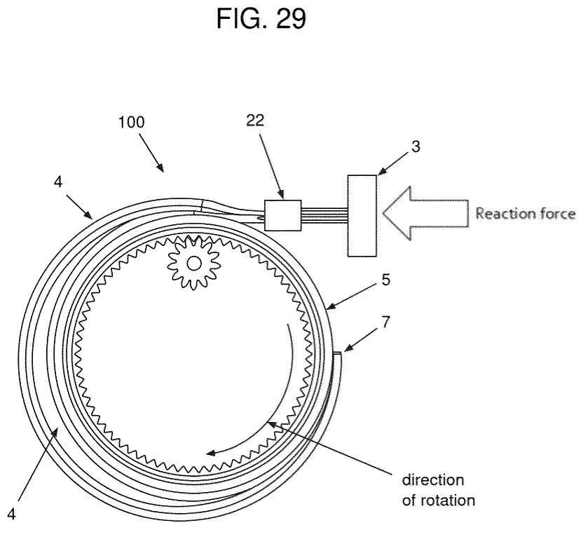

Alternatively, the base structure 48 can comprises a telescopically extendable frame with a dispenser body 45 and two side rods 49 each provided with side rod notches 51 engageable by a frame lock 50. With this configuration, cartridges 1 of different lengths can be firmly hold by the base structure 48 as indicated by FIGS. 28A and 28B in comparison with FIGS. 28C and 28D. For adjusting the base structure 48 to the length of a specific cartridge 1, the frame lock 50 is disengaged by a movement in direction Y indicated in FIG. 28 and the side rods 49 are pushed with respect to the dispenser body 45 in direction X as indicated in FIG. 28C or in the opposed direction. Then, the frame lock 50 is re-engaged with the side rod notches 51.

With respect to the base structure 48 it is pointed to the fact that this is generally configured such that a cartridge 1 can be connected in a fixed but releasable manner thereto. In all of the illustrated configurations the plunger 3 is configured to be moved translationally into a cartridge 1 connected to the base structure 48 for dispensing material from the cartridge 1. A movement of the cartridge 1 with respect to the plunger 3 for dispensing the material from the cartridge is not achieved with the developed configurations.

As described above, the dispensing device 100 can be provided with guiding means in the form of at least one clamshell 52 as illustrated in FIGS. 30A and 30B, at least one low friction plate 53 as illustrated in FIG. 31, at least one, in particular multiple, low friction inserts 54 as illustrated in FIG. 32, and/or at least on, in particular multiple, rollers 55 as illustrated in FIG. 33, to prevent the lifting-off of the driving member 4 from the driving spool 5 upon reaction forces acting on the plunger 3 during a dispensing operation as illustrated in FIG. 29.

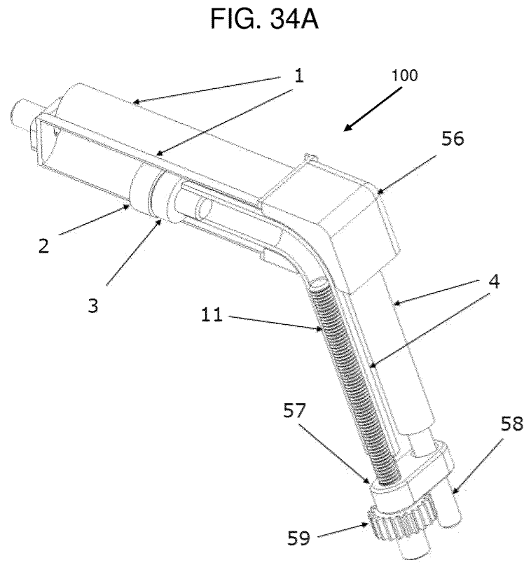

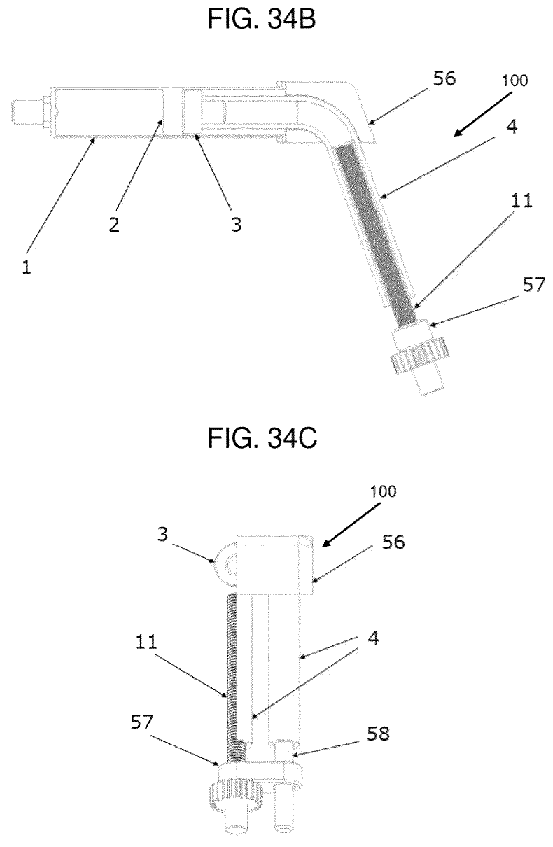

Finally, it is referred to FIGS. 34A to 34C showing a further configuration for a manually driven dispensing device 100 configured to dispense material from 2k cartridge 1.

The dispensing device 100 comprises two driving members 4, one for each cartridge 1. One of the driving members 4 (here the left one) is provided around a threaded drive shaft 11, while the other driving member 4 (here the right one) is provided around a non-threaded guide rod 58. A manually operable drive gear 59 is in threaded engagement with the threaded drive shaft 11 and abuts against a drive plate 57 provided with through-holes for the threaded drive shaft 11 and the guide rod 58. A guide block 56 is provided to guide a dispensing movement of the two driving members 4.

In this configuration, the drive gear 59 can be rotated manually to cause an upwards movement of the drive gear 59 along the threaded drive shaft 11 (due to the threaded engagement of these two components). This upwards movement of the drive gear 59 pushes the drive plate 57 upwards along the threaded drive shaft 11 and the guide rod 58 until it contacts the rear ends of driving members 4. Upon further rotation of the drive gear 59 in the same direction, the drive plate 57 is caused to push the two driving members 4 upwards into the guide block 56 and, thus, against the plungers 3 acting on the pistons 2 for dispensing the materials from the cartridges 1.

Such a configuration can also be implemented for only one cartridge 1, i.e. without the necessity of providing the second driving member 4, the guide rod 58 and the guide plate 57.

The configuration is suitable for all ratios of length to width for the cartridge, but particularly ratios like 10:1, wherein a small spring can be used to compensate free spaces for using smaller cartridges 1.

The system could also use two threaded drive shafts 11, either with two mating drive gears 59 and oppositely threaded drive shafts 11 or an idler gear between the two drive gears 59 and the same thread direction for the drive gears 59.

There may be alternative guide blocks 56 or adjustable guide blocks allowing differing angles for the driving member 4. The guide block 56 could be replaced by rollers or low friction pads or a combination of these to achieve the adjustability. Rollers and low friction pads could also allow for adjustment of the angle in the driving member by the user for different applications.

1. A dispensing device for dispensing viscous and non-viscous material from a cartridge, the dispensing device comprising:
a base structure;
a plunger configured to be moved translationally relative to the base structure;
a driving mechanism configured to cause a dispensing movement of the plunger with respect to the base structure; and
a driving member configured to transmit a driving force from the driving mechanism to the plunger;
the dispensing device comprising
a support member on which the driving member is provided, and a guiding device centering a first end of the driving member on the plunger,
the support member configured to move with respect to the base structure translationally and rotationally during a dispensing movement of the driving member to keep the first end of the driving member centered on the plunger.

2. The dispensing device of claim 1, wherein the driving member is a bendable rod and the support member is a rod drum wrapped by at least a section of the driving member.

3. The dispensing device of claim 1, wherein the support member is provided rotationally fixed but translationally movable on a splined shaft rotatable with respect to the base structure to cause the dispensing movement of the driving member, and the splined shaft is connected to a motor gearbox to rotate the splined shaft.

4. The dispensing device of claim 3, wherein a longitudinal axis of the motor gearbox is aligned in parallel with a longitudinal axis of the cartridge, when connected to the base structure, and the motor gearbox is coupled via at least one of the following components to the splined shaft: a spur gear, a compound gear, a bevel gear, a worm, a wheel, a belt drive, a chain, a sprocket or a friction wheel.

5. The dispensing device of claim 3, wherein the longitudinal axis of the motor gearbox is aligned in perpendicular with the longitudinal axis of the cartridge, when connected to the base structure, and the motor gearbox is coupled directly to the splined shaft.

6. The dispensing device of claim 1, wherein the support member is configured to move translationally in a direction perpendicular with respect to a translational movement direction of the plunger during the dispensing movement.

7. The dispensing device of claim 1, wherein the guiding device comprises a guide bush or at least one, guide wheel.

8. The dispensing device of claim 1, wherein the dispensing device is an electrically driven handheld device and the driving mechanism comprises a motor gearbox.

9. The dispensing device of claim 1, wherein the dispensing device is a floor dispensing device configured to dispense the material from cartridges with a length of more than 0.5 m and.

10. The dispensing device of claim 1, wherein the dispensing device comprises an anti-drip device configured to be operated by a user to release the pressure applied by the driving member onto the plunger and, thus, onto a piston of the cartridge, in particular by causing a small reverse movement of the end section of the driving member connected to the plunger.

11. The dispensing device of claim 10, wherein the anti-drip device comprises an anti-drip finger acting onto the driving member and a guiding device to prevent sheering forces onto the plunger when activating the anti-drip finger.

12. The dispensing device of claim 1, wherein the base structure comprises a connection device to connect a rear end of the cartridge or releasably holding a center portion of the cartridge, the base structure having a length shorter than a length of the cartridge to be connected thereto, or the base structure is configured such that 2k cartridges are capable of being connected in parallel to each other in a fixed but releasable manner to the base structure, the dispensing device comprising one separate plunger and one separate driving member for each cartridge but only one common driving mechanism, the driving mechanism comprising one separate support member for each driving member each driven by one single common motor gearbox.

13. The dispensing device claim 1, wherein the base structure comprises a telescopically extendable frame configuration configured to hold cartridges of different lengths.

14. The dispensing device of claim 1, wherein the base structure is configured such that a cartridge is capable of being connected in a fixed but releasable manner to the base structure.

15. The dispensing device of claim 1, wherein the plunger is configured to be moved translationally into the cartridge connected to the base structure to dispense the material from the cartridge.

16. The dispensing device of claim 1, wherein the dispensing device comprises a stand configured such that the dispensing device is capable of being placed in a substantially vertical orientation stably on a floor.

17. The dispensing device of claim 1, wherein the driving member is bendable and wrapped around the support member, and
the dispensing device is configured such that a rotational movement of the support member results in an unwrapping of the driving member from the driving spool and, thus, a translational axially directed force from the unwinding driving member onto the plunger resulting in a translational dispensing movement of the plunger with respect to the base structure.

18. The dispensing device of claim 1, wherein a first end of the driving member is firmly connected to the plunger and a second end of the driving member is connected to the support member.

19. The dispensing device of claim 1, wherein the driving member is a bendable driving rod coupled in a non-releasable manner to the support member.

20. The dispensing device of claim 19, wherein the driving member is a continuous coil of spring steel, in particular with a diameter of 10 mm to 25 mm,
the coil is formed of a wire with an essentially square cross section or a thickness corresponding to a pitch of the coil.

21. The dispensing device of claim 19, wherein the driving member is formed from first components of flexible material and second components of rigid material coupled to each other such that the driving member is configured to transmit lateral forces along a length thereof but configured to bend upon transversal forces acting thereon, or the driving member is formed of multiple essentially identical segments connected to each other non-releasably, each of the segments second end at least one spring member, joint member or spacer, or
the driving member is formed of multiple essentially identical segments connected to each other non-releasably, each of the segments second end at least one spring member, joint member or spacer.

22-24. (canceled)
